(19) United States
(12) Patent Application Publication
(10) Pub. No.: US 2025/0188992 A1
(43) Pub. Date: Jun. 12, 2025

(54) VEHICULAR WHEEL BEARING INCLUDING SEALING MEMBER HAVING NON-COAXIAL SEALING LIP

(71) Applicant: ILJIN GLOBAL CO., LTD., Seoul (KR)

(72) Inventor: Jong Keun LIM, Seoul (KR)

(73) Assignee: ILJIN GLOBAL CO., LTD., Seoul (KR)

(21) Appl. No.: 19/059,574

(22) Filed: Feb. 21, 2025

Related U.S. Application Data
(63) Continuation of application No. PCT/KR2023/011653, filed on Aug. 8, 2023.

(30) Foreign Application Priority Data
Aug. 22, 2022 (KR) 10-2022-0105137

(51) Int. Cl. F16C 33/78; F16C 19/38

(52) U.S. Cl. CPC F16C 33/7886; F16C 19/386; F16C 2326/02

(57) ABSTRACT

Provided is a vehicular wheel bearing for rotatably mounting and supporting a wheel of a vehicle to a vehicle body. The vehicular wheel bearing includes a rotary element on which the wheel of the vehicle is mounted and configured to rotate together with the wheel of the vehicle; a non-rotary element mounted and fixed to the vehicle body; a plurality of rolling bodies provided between the rotary element and the non-rotary element; and a sealing member provided between the rotary element and the non-rotary element to prevent inflow of external foreign matters or leakage of an internal lubricant oil. The sealing member includes a first member mounted to one of the rotary element and the non-rotary element of the vehicular wheel bearing, and a second member mounted to the other of the rotary element and the non-rotary element of the vehicular wheel bearing.

### CROSS-REFERENCE TO RELATED APPLICATIONS

This application is a continuation of International Application No. PCT/KR2023/011653 filed on Aug. 8, 2023, which claims priority to Korean Patent Application No. 10-2022-0105137 filed on Aug. 22, 2022, the entire contents of which are herein incorporated by reference.

### TECHNICAL FIELD

The present disclosure relates to a vehicular wheel bearing for rotatably mounting and supporting a wheel of a vehicle to a vehicle body, more particularly, to a vehicular wheel bearing in which a non-coaxial sealing lip having a center eccentric with respect to a center of the wheel bearing is provided in a sealing member.

### BACKGROUND

A wheel bearing is used to rotatably mount and support a wheel of a vehicle to a vehicle body. The wheel bearing connects a rotary element to which the wheel is mounted to a non-rotary element fixed to the vehicle body through rolling bodies such that the wheel mounted to the rotary element is supported by the vehicle body while being rotatably mounted to the vehicle body.

Meanwhile, since the wheel bearing is used while being mounted on the wheel of the vehicle, the wheel bearing is likely to be exposed to external foreign matters such as dust and moisture. Therefore, in order to prevent the external foreign matters from being introduced into the wheel bearing, a sealing member may be mounted to the wheel bearing.

Referring to FIG. 1, there is exemplarily illustrated a structure of a vehicular wheel bearing including a sealing member. As illustrated in FIG. 1, a vehicular wheel bearing 10 is configured such that a rotary element 20 to which a wheel of a vehicle is mounted is rotatably mounted to a non-rotary element 30 fixed to a vehicle body through rolling bodies, and a sealing member 50 is provided between the rotary element 20 and the non-rotary element 30 of the wheel bearing to prevent inflow of external foreign matters or leakage of internal lubricant (grease).

Referring to FIG. 2, there is exemplarily illustrated a structure of the sealing member 50 (sealing member provided in the vehicle body) which may be used for the vehicular wheel bearing 10.

As illustrated in FIG. 2, the sealing member 50 may be configured such that an elastic sealing portion 54 is attached to a frame 52 constituting a basic body and a sealing lip 56 provided on the elastic sealing portion 54 is in contact with or is disposed near a counterpart (for example, a slinger 58 in FIG. 2) to perform sealing.

### DETAILED DESCRIPTION

The present disclosure is for the purpose of providing a vehicular wheel bearing configured to include a non-coaxial sealing lip having a center eccentric with respect to a center of a wheel bearing to improve a sealing property.

Representative configurations of the present disclosure to achieve the above aspects are described below.

According to an example embodiment of the present disclosure, there is provided a vehicular wheel bearing for rotatably mounting and supporting a wheel of a vehicle to a vehicle body. The vehicular wheel bearing according to an example embodiment of the present disclosure may include: a rotary element on which the wheel of the vehicle is mounted and configured to rotate together with the wheel of the vehicle; a non-rotary element mounted and fixed to the vehicle body; a plurality of rolling bodies provided between the rotary element and the non-rotary element; and a sealing member provided between the rotary element and the non-rotary element to prevent inflow of external foreign matters or leakage of an internal lubricant. According to an example embodiment of the present disclosure, the sealing member may include a first member mounted to one of the rotary element and the non-rotary element of the vehicular wheel bearing, and a second member mounted to the other of the rotary element and the non-rotary element of the vehicular wheel bearing. According to an example embodiment of the present disclosure, at least one of the first member and the second member of the sealing member may include an elastic sealing portion, the elastic sealing portion includes at least one elastic sealing lip, and the at least one elastic sealing lip may be a non-coaxial sealing lip having a center eccentric with respect to a center of the vehicular wheel bearing.

In an aspect, the center of the non-coaxial sealing lip may be decentered downward with respect to the center of the vehicular wheel bearing.

In an aspect, the elastic sealing lip may further include at least one coaxial sealing lip having a same center as the center of the vehicular wheel bearing.

In an aspect, the non-coaxial sealing lip may be positioned radially outward with respect to the at least one coaxial sealing lip.

In an aspect, the non-coaxial sealing lip may be configured to have a smaller amount of interference than the at least one coaxial sealing lip.

In an aspect, the first member may be mounted on the non-rotary element of the vehicular wheel bearing, and the second member may be mounted on the rotary element of the vehicular wheel bearing.

In an aspect, the non-coaxial sealing lip may be provided on the second member.

In an aspect, the at least one coaxial sealing lip may be provided on the second member.

In an aspect, the rotary element of the vehicular wheel bearing may include a wheel hub with a wheel mounting flange, and an inner ring mounted on an outer circumferential surface of the wheel hub in a press-fitting manner. The non-rotary element of the vehicular wheel bearing may be formed as an outer ring with a vehicle-body-side mounting flange, the first member of the sealing member may be mounted on an inner circumferential surface of the outer ring in the press-fitting manner, and the second member of the sealing member may be mounted on an outer circumferential surface of the inner ring in the press-fitting manner.

In an aspect, the second member of the sealing member may further include an encoder provided on an axial cross section of the vehicle body and configured to measure a rotational speed of the wheel.

Further, the vehicular wheel bearing according to the present disclosure may further include other additional configurations without departing from the technical sprit of the present disclosure.

A vehicular wheel bearing according to an example embodiment of the present disclosure is configured such that a non-coaxial sealing lip having a center eccentric with respect to a center of the wheel bearing is provided in a sealing member. This makes it possible to produce a smooth air flow inside the sealing member due to an unbalanced internal pressure generated by the non-coaxial sealing lip. Therefore, it is possible to easily discharge foreign matters introduced into the sealing member to the outside and improve a sealing property.

### BRIEF DESCRIPTION OF THE DRAWINGS

FIG. 1 exemplarily illustrates a vehicular wheel bearing in the related art.

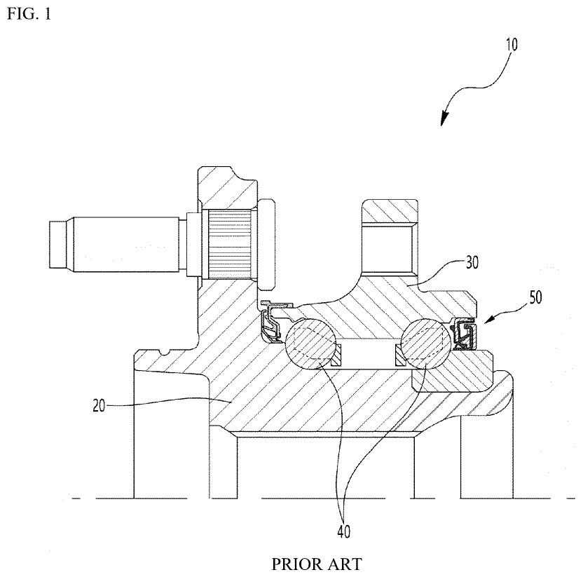

FIG. 2 exemplarily illustrates a structure of a sealing member (vehicle-body-side sealing member) of the vehicular wheel bearing illustrated in FIG. 1.

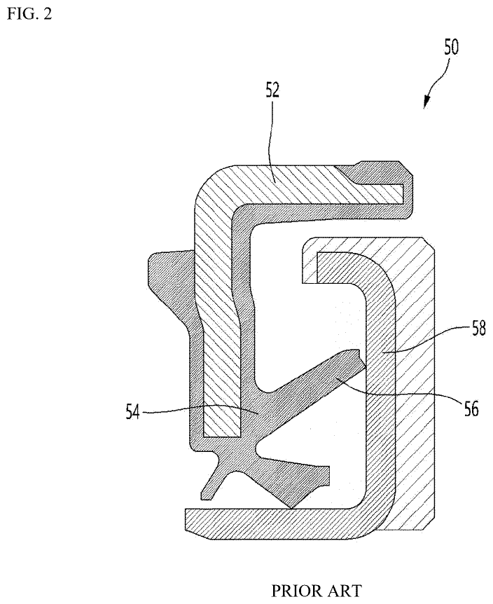

FIG. 3 exemplarily illustrates a structure of a vehicular wheel bearing according to an example embodiment of the present disclosure.

FIG. 4 exemplarily illustrates a structure of a sealing member (vehicle-body-side sealing member) of the vehicular wheel bearing according to an example embodiment of the present disclosure (the illustration of a first member mounted on the outer ring in a press-fitting manner is omitted).

FIG. 5 exemplarily illustrates the structure of the sealing member (vehicle-body-side sealing member) of the vehicular wheel bearing according to an example embodiment of the present disclosure (the illustration of a second member mounted on an inner ring in a press-fitting manner is omitted).

### DETAILED DESCRIPTION

Example embodiments of the present disclosure described below are exemplified for the purpose of describing the technical spirit of the present disclosure. The scope of the claims according to the present disclosure is not limited to the example embodiments described below or to the detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising” “including” “having” and the like used herein should be construed as open-ended terms encompassing the possibility of including other example embodiments.

The term “axial direction” used herein may be defined as a direction extending along a rotational central axis of a wheel bearing, the term “radial direction” used herein may be defined as a direction perpendicular to the axial direction and away from the rotational central axis or approaching the rotational central axis, and the term “circumferential direction” used herein may be defined as a direction rotating about the axial direction described above.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding components. Further, in the following descriptions of the example embodiments, duplicate descriptions of the same or corresponding constituent elements may be omitted. However, even though a description of a constituent element is omitted, such a constituent element is not intended to be excluded in any example embodiment.

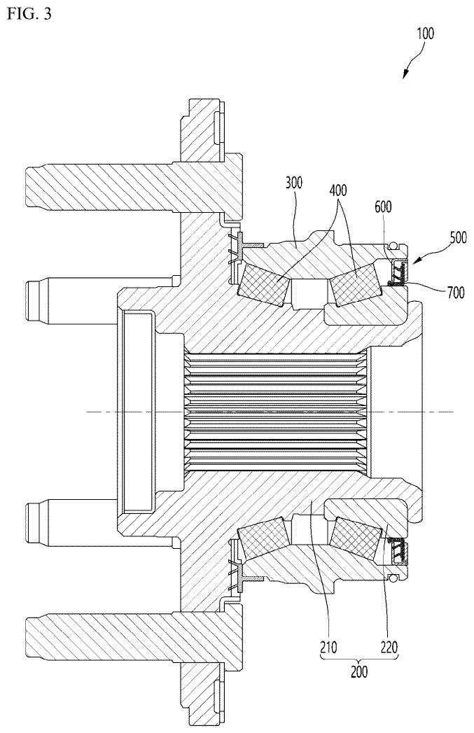

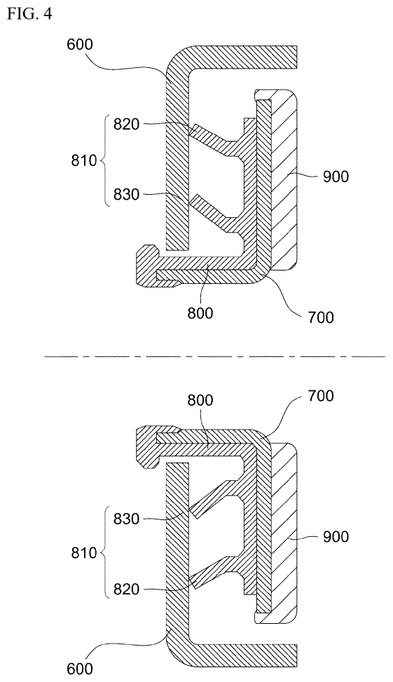

Referring to FIGS. 3 and 4, there is exemplarily illustrated a vehicular wheel bearing 100 according to an example embodiment of the present disclosure. Like a vehicular wheel bearing in the related art, the vehicular wheel bearing 100 according to an example embodiment of the present disclosure may be configured to perform a function of rotatably supporting a wheel of a vehicle relative to a vehicle body by coupling a rotary element 200 (for example, a wheel hub 210 and an inner ring 220) to a non-rotary element 300 (for example, an outer ring) via rolling bodies 400.

According to an example embodiment of the present disclosure, the wheel hub 210 constituting the rotary element 200 may be formed in a substantially cylindrical shape extending along an axial direction. An outer circumferential surface of the wheel hub 210 may be provided with a wheel mounting flange (hub flange). The wheel mounting flange may be formed in a shape extending radially outward from the outer circumferential surface of the wheel hub 210 and may be used to mount the wheel of the vehicle on the wheel hub 210 with hub bolts or the like. Further, an inner ring 220 may be mounted on a vehicle-body-side end portion of the wheel hub 210. A raceway surface (inner raceway surface) may be formed on a portion of the outer circumferential surface of the wheel hub 210 to support the rolling bodies 400 in a radially inward direction.

According to an example embodiment of the present disclosure, one or more inner rings 220 may be mounted on the outer circumferential surface of the wheel hub 210. A raceway surface for the rolling bodies 400 may be formed on an outer circumferential surface of the inner ring 220 to support the rolling bodies 400 in the radially inward direction. For example, the inner ring 220 may be coupled to a seating portion provided at the vehicle-body-side end portion of the wheel hub 210 in a press-fitting manner. As illustrated in FIG. 3, the inner ring 220 may be configured to be supported on/fixed to the wheel hub 110 by plastically deforming the vehicle-body-side end portion of the wheel hub 110 in a radially outward direction or fastening nuts or the like to the vehicle-body-side end portion of the wheel hub 110.

According to an example embodiment of the present disclosure, the outer ring constituting the non-rotary element 300 may include a vehicle-body-side mounting flange formed on an outer circumferential surface thereof to mount the wheel bearing on the vehicle body. The outer ring may be configured to have a raceway surface (outer raceway surface) formed on an inner circumferential surface thereof and in contact with the rolling bodies 400. The raceway surface (outer raceway surface) formed on the inner circumferential surface of the outer ring may be configured to accommodate and support the rolling bodies 140 as rolling elements between the outer raceway surface and the inner raceway surface in cooperation with the raceway surface (inner raceway surface) formed on the wheel hub 210 and/or the inner ring 220.

According to an example embodiment of the present disclosure, the rolling bodies 400 may be disposed between the rotary element 200 and the non-rotary element 300 of the vehicular wheel bearing 100 to perform a function of rotatably supporting the rotary element 200 of the vehicular wheel bearing 100 relative to the non-rotary element 300.

However, in the case of the example embodiments illustrated in the figures, the wheel bearing has been described to have a configuration in which one raceway surface for supporting the rolling bodies is directly formed on a portion of the outer circumferential surface of the wheel hub, but the vehicular wheel bearing according to an example embodiment of the present disclosure is not limited thereto. Alternatively, the vehicular wheel bearing may be modified to have other various configurations, such as a configuration in which two inner rings are mounted on the wheel hub to support the rolling bodies.

According to an example embodiment of the present disclosure, a sealing member 500 may be provided on one side or both sides of the vehicular wheel bearing 100 to prevent external foreign matters from flowing into a bearing space in which the rolling bodies 400 are disposed or prevent internal lubricant from leaking to the outside.

Referring to FIG. 4, the sealing member 500 (a wheel-side sealing member in this example) mounted on one side of the vehicular wheel bearing 100 according to an example embodiment of the present disclosure is exemplarily illustrated.

As illustrated in FIG. 4, the sealing member 500 of the vehicular wheel bearing 100 according to an example embodiment of the present disclosure may be formed to have a structure substantially similar to a typical sealing member for wheel bearing of a pack seal structure.

For example, according to an example embodiment of the present disclosure, the sealing member 500 may include a first member 600 mounted on one of the rotary element 200 and the non-rotary element 300 of the vehicular wheel bearing 100, and a second member 700 mounted on the other of the rotary element 200 and the non-rotary element 300 of the vehicular wheel bearing 100.

For example, in a case of the example embodiment illustrated in the figure, the first member 600 of the sealing member 500 is mounted on the outer ring constituting the non-rotary element 300 of the vehicular wheel bearing 100, and the second member 700 of the sealing member 500 is mounted on the inner ring 220 constituting the rotary element 200 of the vehicular wheel bearing 100.

According to an example embodiment of the present disclosure, at least one of the first member 600 and the second member 700 of the sealing member 500 may include an elastic sealing portion 800. At least one of the elastic sealing portions 800 may include at least one elastic sealing lip 810.

For example, in a case of the example embodiment illustrated in the figure, the elastic sealing portion 800 may be provided on the second member 700 of the sealing member 500. The elastic sealing lip 810 of the elastic sealing portion 800 is in contact with or disposed near the first member 600 to perform sealing.

According to an example embodiment of the present disclosure, the at least one elastic sealing lip 810 may include a non-coaxial sealing lip 820 having a center decentered respect to the center of the vehicular wheel bearing 100.

According to an example embodiment of the present disclosure, the non-coaxial sealing lip 820 may be disposed at a position decentered downward with respect to the center of the vehicular wheel bearing 100.

According to an example embodiment of the present disclosure, the elastic sealing lip 810 may further include at least one coaxial sealing lip 830 having a center identical to the center of the vehicular wheel bearing 100. The non-coaxial sealing lip 820 may be positioned radially outward with respect to the coaxial sealing lip 830.

With this configuration, by the non-coaxial sealing lip 820, an unbalanced pressure distribution is formed in a space between the sealing lips when the wheel bearing is rotated. This increases a flow of air inside the space, which provides an effect of discharging foreign matters or moisture introduced into the sealing member to the outside.

In the example embodiment illustrated in the figures, the elastic sealing portion 800 of the sealing member 500 has been described to include one non-coaxial sealing lip 820 and one coaxial sealing lip 830, but the present disclosure is not limited thereto. As an example, a plurality of non-coaxial sealing lips 820 and a plurality of coaxial sealing lips 830 may be provided.

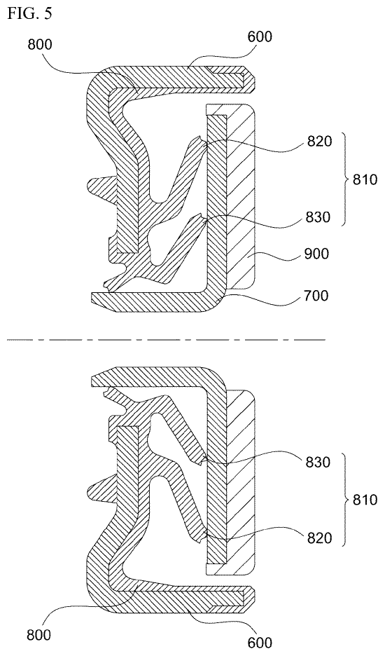

Further, in the example embodiment illustrated in the figure, both the non-coaxial sealing lip 820 and the coaxial sealing lip 830 have been described to be provided on the second member 700 of the sealing member 500. However, as illustrated in FIG. 5, both the non-coaxial sealing lip 820 and the coaxial sealing lip 830 may be provided on the first member 600. Alternatively, the non-coaxial sealing lip 820 and the coaxial sealing lip 830 may be provided on the first member 600 and the second member 700, respectively.

Further, as illustrated in the figures, an encoder 900 may be provided on one side of the sealing member 500, for example, on a vehicle-body-side axial cross section of the second member 700 constituting the sealing member 500 to measure a rotational speed of the wheel.

Although the present disclosure has been described above in terms of specific items such as detailed constituent elements as well as the limited example embodiments and the drawings, they are merely provided to help more general understanding of the present disclosure, and the present disclosure is not limited to the above example embodiments. Various modifications and changes could have been realized by those skilled in the art to which the present disclosure pertains from the above description.

Therefore, the spirit of the present disclosure need not to be limited to the above-described example embodiments, and in addition to the appended claims to be described below, and all ranges equivalent to or changed from these claims need to be the to belong to the scope and spirit of the present disclosure.

### EXPLANATION OF REFERENCE NUMERALS

100: Vehicular wheel bearing
200: Rotary element (of vehicular wheel bearing)
210: Wheel hub
220: Inner ring
300: Non-rotary element (of vehicular wheel bearing)
400: Rolling body
500: Sealing member
600: First member (of sealing member)
700: Second member (of sealing member)
800: Elastic sealing portion
810: Elastic sealing lip
820: Non-coaxial sealing lip
830: Coaxial sealing lip
900: Encoder

What is claimed is:

1. A vehicular wheel bearing (100) for rotatably mounting and supporting a wheel of a vehicle to a vehicle body, the vehicular wheel bearing (100) comprising:
a rotary element (200) on which the wheel of the vehicle is mounted and configured to rotate together with the wheel of the vehicle;
a non-rotary element (300) mounted and fixed to the vehicle body;
a plurality of rolling bodies (400) provided between the rotary element (200) and the non-rotary element (300); and
a sealing member (500) provided between the rotary element (200) and the non-rotary element (300) to prevent inflow of external foreign matters or leakage of an internal lubricant,
wherein the sealing member (500) includes a first member (600) mounted to one of the rotary element (200) and the non-rotary element (300) of the vehicular wheel bearing (100), and a second member (700) mounted to the other of the rotary element (200) and the non-rotary element (300) of the vehicular wheel bearing (100),
wherein at least one of the first member (600) and the second member (700) of the sealing member (500) includes an elastic sealing portion (800),
wherein at least one of the elastic sealing portions (800) includes at least one elastic sealing lip (810), and
wherein at least one of the elastic sealing lips (810) is a non-coaxial sealing lip (820) having a center eccentric with respect to a center of the vehicular wheel bearing (100).

2. The vehicular wheel bearing (100) of claim 1, wherein the center of the non-coaxial sealing lip (820) is decentered downward with respect to the center of the vehicular wheel bearing (100).

3. The vehicular wheel bearing (100) of claim 2, wherein the elastic sealing lip (810) further includes at least one coaxial sealing lip (830) having a same center as the center of the vehicular wheel bearing (100).

4. The vehicular wheel bearing (100) of claim 3, wherein the non-coaxial sealing lip (820) is positioned radially outward with respect to the at least one coaxial sealing lip (830).

5. The vehicular wheel bearing (100) of claim 4, wherein the non-coaxial sealing lip (820) is configured to have a smaller amount of interference than the at least one coaxial sealing lip (830).

6. The vehicular wheel bearing (100) of claim 5, wherein the first member (600) is mounted on the non-rotary element (300) of the vehicular wheel bearing (100), and
wherein the second member (700) is mounted on the rotary element (200) of the vehicular wheel bearing (100).

7. The vehicular wheel bearing (100) of claim 6, wherein the non-coaxial sealing lip (820) is provided on the second member (700).

8. The vehicular wheel bearing (100) of claim 7, wherein the at least one coaxial sealing lip (830) is provided on the second member (700).

9. The vehicular wheel bearing (100) of claim 8, wherein the rotary element (200) of the vehicular wheel bearing (100) includes a wheel hub (210) with a wheel mounting flange, and an inner ring (220) mounted on an outer circumferential surface of the wheel hub (210) in a press-fitting manner,
wherein the non-rotary element (300) of the vehicular wheel bearing (100) is formed as an outer ring with a vehicle-body-side mounting flange,
wherein the first member (600) of the sealing member (500) is mounted on an inner circumferential surface of the outer ring in the press-fitting manner, and
wherein the second member (700) of the sealing member (500) is mounted on an outer circumferential surface of the inner ring (220) in the press-fitting manner.

10. The vehicular wheel bearing (100) of claim 9, wherein the second member (700) of the sealing member (500) further includes an encoder (900) provided on an axial cross section of the vehicle body and configured to measure a rotational speed of the wheel.
